(19) United States
(12) Patent Application Publication
(10) Pub. No.: US 2026/0365147 A1
(43) Pub. Date: Nov. 19, 2026

(54) ELECTRO-MECHANICAL BRAKING APPARATUS BASED ON ZONAL ARCHITECTURE AND CONTROL METHOD THEREOF

(71) Applicant: HYUNDAI MOBIS CO., LTD., Seoul (KR)

(72) Inventor: Jong Sung KIM, Yongin-si (KR)

(73) Assignee: HYUNDAI MOBIS CO., LTD., Seoul (KR)

(21) Appl. No.: 19/407,789

(22) Filed: Dec. 3, 2025

(30) Foreign Application Priority Data
May 13, 2025 (KR) 10-2025-0062060

(51) Int. Cl. B60T 8/88; B60T 8/171; B60T 8/172; B60T 8/1761; B60T 8/32; B60T 8/92

(52) U.S. Cl. CPC B60T 8/885; B60T 8/171; B60T 8/172; B60T 8/17616; B60T 8/321; B60T 8/92; B60T 2240/00; B60T 2250/04; B60T 2270/402; B60T 2270/406; B60T 2270/413

(57) ABSTRACT

A zonal architecture-based electro-mechanical braking apparatus includes: a central computer that is communicatively connected to a first zone control unit and a second zone control unit; a front left (FL) brake wheel control unit (BWCU) that is communicatively connected to the first zone control unit and also serves as a first central control unit; a front right (FR) BWCU that is communicatively connected to the second zone control unit and also serves as a second central control unit; a rear right (RR) BWCU that monitors the FL BWCU and other BWCUs except the FL BWCU; and a rear left (RL) BWCU that monitors the FR BWCU and other BWCUs except the FR BWCU. The FL BWCU, the RR BWCU, and the RL BWCU are interconnected through a first local communication line, and the FR BWCU, the RR BWCU, and the RL BWCU are interconnected through a second local communication line.

### CROSS REFERENCE TO RELATED APPLICATION

The present application claims priority and the benefit of Korean Patent Application No. 10-2025-0062060, filed on May 13, 2025, in the Korean Intellectual Property Office, the entire disclosure of which is incorporated herein by reference.

### BACKGROUND

### FIELD

The present disclosure relates to an electro-mechanical braking (EMB) apparatus for a vehicle, and more particularly, to an EMB apparatus optimized for zonal architecture and a control method thereof.

### DISCUSSION OF THE BACKGROUND

In general, in an EMB system (i.e., an electro-mechanical braking apparatus), a pedal simulator is mounted on the driver’s pedal, so that the amount of pedal input from the driver is sensed by a sensor, and the information is transmitted to a brake central control unit (BCCU).

The BCCU calculates the braking force required for each wheel and sends a brake demand to a brake wheel control unit (BWCU) mounted on each wheel. The BWCU then operates an EMB actuator mounted on each wheel (specifically, by operating the motor) to generate braking force electromechanically.

The EMB system (i.e., electro-mechanical braking apparatus) enables active braking and independent braking of each wheel, and thus has the advantage of being able to perform all functions required for the braking apparatus (service braking, ABS, VDC, TCS, EPB, etc.).

However, in the EMB system, each wheel must be equipped with an independent actuator (motor), and the brake central control unit (BCCU) for controlling the entire system and the brake wheel control unit (BWCU) for each wheel must be configured separately, thereby increasing the number of motors to four, and the number of control units to six: two brake central control units (BCCUs) to which redundancy is applied, and four brake wheel control units (BWCUs). As a result, the number of components of the EMB system (i.e., the electro-mechanical braking apparatus) increases, thereby increasing the manufacturing cost compared to conventional hydraulic braking systems.

The Zonal architecture recently applied to vehicles has a distributed control structure that divides the entire vehicle into several functional zones and places a local control unit in each zone to control the sensors and actuators in that area. However, in this zonal architecture environment, it is difficult to apply the existing centralized electro-mechanical braking (EMB) apparatus as it is. In particular, the communication path between the actuators (motors) mounted on each wheel and the brake central control unit (BCCU) can become long and complex, and this communication structure does not align with the design intent of the zonal architecture, and therefore, it is necessary to optimize the communication structure and redesign the control method to be suitable for the intent.

In other words, there is a need for a technology that can simultaneously achieve cost reduction and communication structure optimization by developing an EMB apparatus optimized for the zonal architecture.

The background technology of the present disclosure is disclosed in Korean Patent Laid-Open Publication No. 10-2023-0147984 (published on Oct. 24, 2023).

### SUMMARY

The present disclosure is intended to solve the above-mentioned problems, and its object is to provide an electro-mechanical braking (EMB) apparatus based on a zonal architecture and a control method thereof.

According to one aspect, the present disclosure aims to realize cost reduction and system structure simplification when applying an EMB apparatus to a zonal architecture, and its object is to provide a zonal architecture-based electro-mechanical braking apparatus and a control method thereof, which simultaneously achieve a distributed control logic and an efficient control structure by deleting a brake central control unit (BCCU) that was essential in existing systems, while not imposing the control function on the zone control unit but configuring the brake wheel control unit (BWCU) mounted on each wheel to directly perform the control function.

According to another aspect, another object of the present disclosure is to provide a zonal architecture-based electro-mechanical braking apparatus and a control method thereof, which can simultaneously secure functional safety and system scalability by avoiding a structure in which the zone control unit is required to meet functional safety requirements of high safety level (ASIL D), and thus executing major braking control functions (e.g., ABS, VDC, etc.) in the brake wheel control unit (BWCU), and distributing the decisions on additional functions or integrated control linked with some steering systems or other systems to be performed in the zone control unit.

A zonal architecture-based electro-mechanical braking apparatus according to one aspect of the present disclosure includes: a central computer that is communicatively connected to a first zone control unit and a second zone control unit; a front left (FL) brake wheel control unit (BWCU) that is communicatively connected to the first zone control unit and also serves as a first central control unit; a front right (FR) BWCU that is communicatively connected to the second zone control unit and also serves as a second central control unit; a rear right (RR) BWCU that monitors the FL BWCU; and a rear left (RL) BWCU that monitors the FR BWCU, wherein the FL BWCU, the RR BWCU, and the RL BWCU are interconnected through a first local communication line, and the FR BWCU, the RR BWCU, and the RL BWCU are interconnected through a second local communication line.

In the present disclosure, the apparatus may further include a FL wheel speed sensor (WSS) connected to the FL BWCU; a FR WSS connected to the FR BWCU; a RR WSS connected to the RR BWCU; and a RL WSS connected to the RL BWCU, wherein each BWCU receives wheel speed information from each WSS and uses the information for braking control.

In the present disclosure, the FL BWCU and the FR BWCU may each independently drive ABS control software, and directly detect wheel speed through respectively connected wheel speed sensors (WSSs) to perform real-time ABS control for the front wheels.

In the present disclosure, the FL BWCU and the FR BWCU may receive WSS information not only from the wheels to which they are directly connected, but also from other BWCUs through local communication, and share, in real time, the data required for estimated vehicle speed calculation and brake force distribution.

In the present disclosure, when the FL BWCU fails, the RR BWCU may detect the failure of the FL BWCU and transmit the failure information to the FR BWCU, and the FR BWCU may back up and perform the control function, including the control area that the FL BWCU was in charge of.

In the present disclosure, when the FR BWCU fails, the RL BWCU may detect the failure of the FR BWCU and transmit the failure information to the FL BWCU, and the FL BWCU may back up and perform the control function, including the control area that the FR BWCU was in charge of.

In the present disclosure, according to a designated brake demand determination method, the FL BWCU may determine a brake demand for the FL and RR, and the FR BWCU may determine a brake demand for the FR and RL.

In the present disclosure, according to a designated brake demand determination method, the FL BWCU may determine a brake demand for the FL, RR and RL, and the FR BWCU may determine a brake demand only for the FR.

In the present disclosure, the FL BWCU and the FR BWCU may operate based on the same control software, so that even if the decision-making entities for calculating a brake demand are divided, the brake demand as a result of calculation may be the same or substantially the same level of brake demand.

According to another aspect of the present disclosure, there is provided a method for controlling a zonal architecture-based electro-mechanical braking apparatus in which a front left (FL) brake wheel control unit (BWCU) communicatively connected to a first zone control unit also serves as a first central control unit, and a front right (FR) BWCU communicatively connected to a second zone control unit also serves as a second central control unit, the method including steps of: interconnecting the FL BWCU, the rear right (RR) BWCU, and the rear left (RL) BWCU through a first local communication line; interconnecting the FR BWCU, the RR BWCU, and the RL BWCU through a second local communication line; allowing the RR BWCU to monitor the FL BWCU, and the RL BWCU to monitor the FR BWCU; when the FL BWCU fails, allowing the RR BWCU to transmit the failure information to the FR BWCU, and allowing the FR BWCU to back up and perform the control function including the control area that the FL BWCU was in charge of; and when the FR BWCU fails, allowing the RL BWCU to transmit the failure information to the FL BWCU, and allowing the FL BWCU to back up and perform the control function including the control area that the FR BWCU was in charge of.

The present disclosure removes the brake central control unit (BCCU) from an existing electro-mechanical braking apparatus and configures the control function so that the FL BWCU and FR BWCU, which are wheel control units of the front wheels, serve as the first central control unit and the second central control unit, respectively, thereby reducing the number of control units and thus reducing the system cost. Furthermore, the present disclosure distributes some integrated control functions to zone control units, and performs core braking control functions, such as ABS and VDC, in each wheel control unit, thereby simultaneously realizing decentralization of the overall system structure and improved efficiency.

According to one aspect, the present disclosure secures communication redundancy within a local area by connecting the FL BWCU, the RR BWCU, and the RL BWCU through a first local communication line (LOCAL_COMM1) and connecting the FR BWCU, the RR BWCU, and the RL BWCU through a second local communication line (LOCAL_COMM2), and is configured such that when the first central control unit (FL BWCU) fails, the RR BWCU monitors the failure and transmits the status to the FR BWCU, and the FR BWCU can take over the control function. Conversely, when a failure occurs in the second central control unit (FR BWCU), the RL BWCU monitors the status and transmits it to the FL BWCU, thereby enabling backup control. Thereby, functional safety can be maintained even when a failure occurs.

According to another aspect, the present disclosure allows the FL BWCU and FR BWCU to independently drive ABS control software, allows each control unit to perform ABS control in real time using signals from a directly connected wheel speed sensor (WSS), and allows the rear wheel speed sensor information to be transmitted and shared by the RR BWCU and RL BWCU, respectively. This structure removes communication delays that may occur in existing centralized control, and enables fast and accurate ABS response, particularly in front wheel braking control, thereby improving braking performance and reducing response time.

### BRIEF DESCRIPTION OF THE DRAWINGS

FIG. 1 is an exemplary diagram showing a schematic configuration of a zonal architecture-based electro-mechanical braking apparatus according to one embodiment of the present disclosure.

FIGS. 2 and 3 are flowcharts for describing a monitoring and backup control method in the event of a brake wheel control unit (BWCU) failure according to one embodiment of the present disclosure.

FIGS. 4 and 5 are exemplary diagrams for describing a comparative configuration of a brake demand determination method of an electro-mechanical braking apparatus according to one embodiment of the present disclosure.

### DETAILED DESCRIPTION OF THE ILLUSTRATED EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

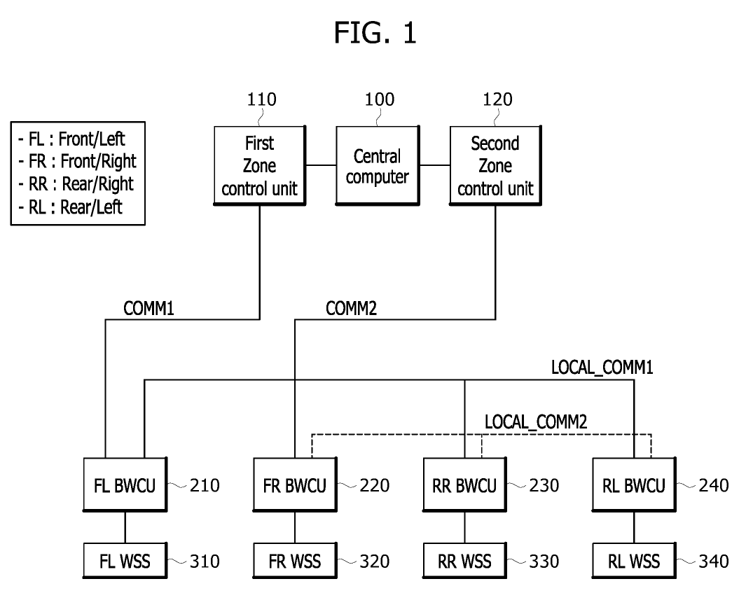

FIG. 1 is an exemplary diagram showing a schematic configuration of a zonal architecture-based electro-mechanical braking apparatus according to one embodiment of the present disclosure.

Referring to FIG. 1, a zonal architecture-based electro-mechanical braking apparatus according to one embodiment of the present disclosure includes: a first zone control unit 110, a central computer 100, a second zone control unit 120, a FL BWCU 210, a FR BWCU 220, a RR BWCU 230, a RL BWCU 240, a FL WSS 310, a FR WSS 320, a RR WSS 330, and a RL WSS 340.

The central computer 100 is a high-level integrated control unit that generates high-level control demands related to driving control, power distribution, steering, braking request, and the like of the entire vehicle and transmits the same to each of the zone control units 110 and 120, and may be configured to interoperate with a vehicle control unit (VCU) or a central control system.

For reference, the central computer 100 may be referred to by various names, such as a main computer, a main processor, or a processor, in other embodiments.

In the present embodiment, the central computer 100 may operate in conjunction with other vehicle systems in addition to the braking system, and performs a function of transmitting braking-related integrated demands (brake demand value (BDV), etc.) to each zone control unit.

The first zone control unit 110 is a control unit located in the front left area of the vehicle, receives control demands from the central computer 100, communicates directly with the FL BWCU 210, and performs control signal transmission and status monitoring functions within the zone.

Furthermore, the first zone control unit 110 may be configured to perform interoperative control with other systems (e.g., a steering system, EPB, etc.) in addition to the EMB system (i.e., an electro-mechanical braking apparatus).

The second zone control unit 120 is a control unit located in the front right area of the vehicle, receives control demands from the central computer 100, communicates directly with the FR BWCU 220, and performs control signal transmission and interoperative control within the zone.

In the present embodiment, the first and second zone control units 110 and 120 are configured not to be responsible for major operations within the EMB system (i.e., electro-mechanical braking apparatus), thereby avoiding functional safety level (e.g., ASIL D) requirements, while still being able to perform specific additional functions or linkage control demand determination functions with other systems.

The FL BWCU 210 also serves as the first central control unit, and the FR BWCU 220 also serves as the second central control unit.

The FL BWCU 210, RR BWCU 230, and RL BWCU 240 are interconnected through a first local communication line (LOCAL_COMM1) (i.e., form one local network).

The FR BWCU 220, RR BWCU 230, and RL BWCU 240 are interconnected through a second local communication line (LOCAL_COMM2) (i.e., form another local network).

The BWCUs 210, 220, 230, and 240 are directly connected to wheel speed sensors (WSSs) 310, 320, 330, and 340 of the corresponding wheels, respectively.

For example, the FL BWCU 210 is connected to the FL WSS 310, the FR BWCU 220 is connected to the FR WSS 320, the RR BWCU 230 is connected to the RR WSS 330, and the RL BWCU 240 is connected to the RL WSS 340.

The present embodiment removes the brake central control unit (BCCU) of the existing electro-mechanical braking apparatus, and configures its function to be shared by the first and second zone control units 110 and 120 and the respective BWCUs 210, 220, 230, and 240. In this case, some of the control functions are performed by the zone control units 110 and 120, and major braking functions such as ABS and VDC are directly performed by each BWCU, thereby reducing the cost of the electro-mechanical braking apparatus while ensuring necessary braking functions (e.g., service braking, ABS, VDC, TCS, EPB, etc.) and safety.

In FIG. 1, FL, FR, RR, and RL represent front/left, front/right, rear/right, and rear/left, respectively.

Furthermore, one of the main features of the present embodiment is that the high-level communication line, which receives external signals from the vehicle control unit (VCU), and the local communication line, which exchanges data between control units within the electro-mechanical braking (EMB) apparatus, are physically/logically separated and operate independently. Unlike conventional centralized designs, this separated structure allows for faster and more stable processing of real-time control communications within the braking apparatus (EMB system).

In the present embodiment, all BWCUs 210, 220, 230, and 240 can be controlled only by a local communication structure based on two CAN lines (CAN FD), and Ethernet may be used as a replacement for one of the communication lines for the front wheels (BWCUs 210 and 220).

In this case, the first and second communication lines (COMM1 and COMM2) illustrated in FIG. 1 represent high-level communication lines connected to the vehicle control unit (VCU), and these lines may be implemented by selecting either CAN FD or Ethernet.

This separated structure can be designed without increasing the number of additional communication lines or pins, thereby having the advantage of securing wiring efficiency and braking apparatus (EMB system) design flexibility.

In particular, the present embodiment is configured to ensure the functional safety of the braking apparatus (EMB system) through a monitoring control unit structure.

Here, the term "monitoring control unit" refers to a BWCU including logic that monitors the operating status of the main wheel control unit (BWCU) and, in the event of a failure, transmits status information to other wheel control units to enable replacement of the control function.

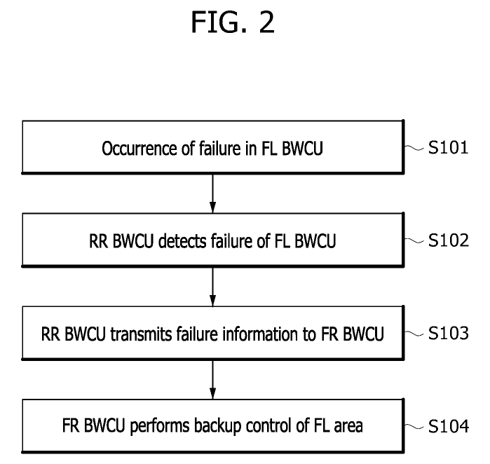

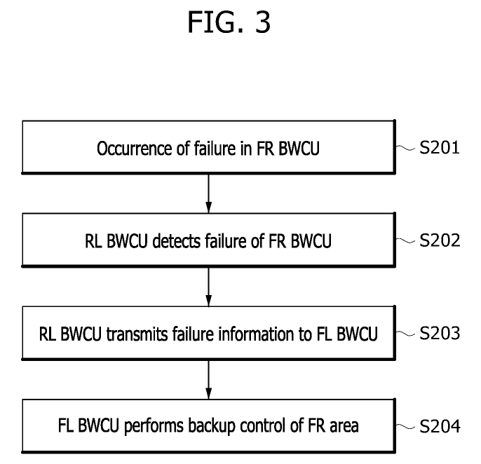

FIGS. 2 and 3 are flowcharts for describing a monitoring and backup control method in the event of a wheel control unit (BWCU) failure according to one embodiment of the present disclosure.

For example, as illustrated in FIG. 2, first, when a failure occurs in the FL BWCU 210 (S101), the RR BWCU 230 monitors the status of the FL BWCU 210 and detects the failure (S102). Thereafter, the RR BWCU 230 transmits the detected failure information to the FR BWCU 220 (S103), and the FR BWCU 220 backs up and performs the control function including the control area that the FL BWCU 210 was in charge of (S104).

Conversely, as illustrated in FIG. 3, first, when a failure occurs in the FR BWCU 220 (S201), the RL BWCU 240 monitors the operating status of the FR BWCU 220 and detects the failure (S202). Thereafter, the RL BWCU 240 transmits the detected failure information to the FL BWCU 210 (S203), and the FL BWCU 210 backs up and performs the control function, including the control area that the FR BWCU 220 was in charge of (S204).

This monitoring control unit-based structure enables stable operation of the entire braking apparatus (EMB system) even in the event of a failure of one wheel control unit, thereby satisfying redundancy design and functional safety requirements (e.g., ISO 26262).

In addition, the present embodiment can improve ABS control performance.

For reference, in the conventional structure, the signal measured from the wheel speed sensor (WSS) connected to each wheel was transmitted to the brake central control unit (BCCU) through the brake wheel control unit (BWCU), and the brake central control unit (BCCU) performed ABS operation and then sent a demand back to the brake wheel control unit (BWCU), so there was a problem in that communication delay and reduced control response speed could occur.

In contrast, in the present embodiment, the FL BWCU 210 and FR BWCU 220 each independently drive ABS control software, and directly detect wheel speed through respectively connected wheel speed sensors (WSSs), thereby enabling real-time ABS control for the front wheels. Therefore, no communication delay occurs in the front wheel ABS control.

In particular, in the present embodiment, wheel slip prevention control for each wheel is directly performed through the wheel speed sensor (WSS) directly connected to each wheel, and the target wheel speed required to determine the presence or absence of slip in the wheel is calculated by receiving information from all four wheels. In this case, the FL BWCU 210 and FR BWCU 220 are not connected by direct communication, and therefore, when controlling ABS, the wheel speed sensor (WSS) value of the FL BWCU 210 is transmitted to the FR BWCU 220 through the RR BWCU 230, and similarly, the wheel speed sensor (WSS) value of the FR BWCU 220 is transmitted to the FL BWCU 210 through the RL BWCU 240.

Meanwhile, communication delays may still occur from the perspective of rear wheel control units, but considering the vehicle braking characteristics in which a significant portion of the braking force is generally concentrated on the front wheels, simply performing ABS control for the front wheels without communication delay can significantly improve performance compared to the existing method.

Here, the ABS control of the FL BWCU 210 and the ABS control of the FR BWCU 220 are performed independently, similar to general service braking control (which generally refers to the basic braking control function that operates when the driver presses the brake pedal, that is, the control function of the braking apparatus routinely used to decelerate or stop the vehicle during normal driving).

However, since the two control units (FL BWCU 210, FR BWCU 220) operate based on the same control software, the decision-making entities for calculating the brake demand may be divided, but the brake demand as a result of the calculation may be determined to be the same or nearly the same value.

Additionally, each brake wheel control unit (BWCU) receives WSS information from the rear wheel BWCU (i.e., the RR BWCU and the RL BWCU) through local communication in addition to the wheel to which it is directly connected, and shares, in real time, the data required for estimated vehicle speed calculation and brake force distribution, thereby ensuring more precise and stable control performance even in front wheel-centered high-speed braking situations.

The brake demands for the rear wheel control units may be divided and handled separately, or one unit may determine all brake demands. Specifically, the following brake demand determination method may be applied.

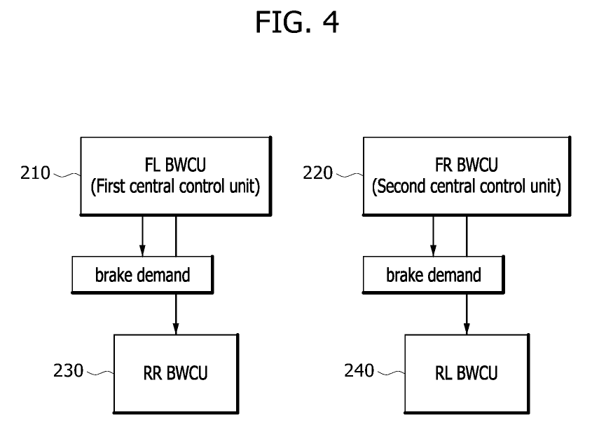

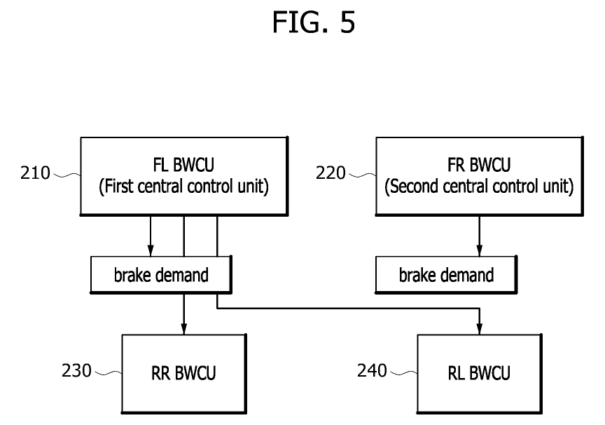

FIGS. 4 and 5 are exemplary diagrams for describing a comparative configuration of a brake demand determination method of an electro-mechanical braking apparatus according to one embodiment of the present disclosure.

(1) A method in which the FL BWCU 210 determines (judges) brake demands for the FL and RR, and the FR BWCU 220 determines (judges) brake demands for the FR and RL (see FIG. 4), and (2) a method in which the FL BWCU 210 determines (judges) brake demands for the FL, RR, and RL, and the FR BWCU 220 determines (judges) brake demands only for the FR (see FIG. 5) may be included.

This configuration enables the implementation of an electro-mechanical braking apparatus optimized for the zonal architecture, and provides a technical effect of improving braking responsiveness and safety through an ABS control structure that removes communication bottlenecks compared to the existing central control method.

As described above, the present embodiment removes the brake central control unit (BCCU) from an existing electro-mechanical braking apparatus and configures the control function so that the FL BWCU and FR BWCU, which are wheel control units of the front wheels, serve as the first central control unit and the second central control unit, respectively, thereby reducing the number of control units and thus reducing the system cost. In addition, some integrated control functions are distributed to the zone control units, and core braking control functions, such as ABS and VDC, are performed by each wheel control unit, thereby simultaneously realizing decentralization of the overall system structure and improved efficiency.

In addition, the present embodiment secures communication redundancy within a local area by connecting the FL BWCU 210, the RR BWCU 230, and the RL BWCU 240 through a first local communication line (LOCAL_COMM1) and connecting the FR BWCU 220, the RR BWCU 230, and the RL BWCU 240 through a second local communication line (LOCAL_COMM2), and is configured such that when the first central control unit (FL BWCU) 210 fails, the RR BWCU 230 monitors the failure and transmits the status to the FR BWCU 220, and the FR BWCU 220 can take over the control function. Conversely, when a failure occurs in the second central control unit (FR BWCU 220), the RL BWCU 240 monitors the status and transmits it to the FL BWCU 210, thereby enabling backup control. This has an effect of maintaining functional safety even when a failure occurs.

In addition, the present embodiment allows the FL BWCU 210 and FR BWCU 220 to independently drive ABS control software, allows each control unit to perform ABS control in real time using signals from a directly connected wheel speed sensor (WSS), and allows the rear wheel speed sensor information to be transmitted and shared by the RR BWCU 230 and RL BWCU 240, respectively. This structure removes communication delays that may occur in existing centralized control and enables fast and accurate ABS response, particularly in front wheel braking control, thereby having the effect of improving braking performance and reducing response time.

What is claimed is:

1. A zonal architecture-based electro-mechanical braking apparatus comprising:
a central computer that is communicatively connected to a first zone control unit and a second zone control unit;
a front left (FL) brake wheel control unit (BWCU) that is communicatively connected to the first zone control unit and also serves as a first central control unit;
a front right (FR) BWCU that is communicatively connected to the second zone control unit and also serves as a second central control unit;
a rear right (RR) BWCU that monitors the FL BWCU; and
a rear left (RL) BWCU that monitors the FR BWCU,
wherein the FL BWCU, the RR BWCU, and the RL BWCU are interconnected through a first local communication line, and the FR BWCU, the RR BWCU, and the RL BWCU are interconnected through a second local communication line.

2. The braking apparatus of claim 1, further comprising:
a FL wheel speed sensor (WSS) connected to the FL BWCU;
a FR WSS connected to the FR BWCU;
a RR WSS connected to the RR BWCU; and
a RL WSS connected to the RL BWCU,
wherein each BWCU receives wheel speed information from each WSS and uses the information for braking control.

3. The braking apparatus of claim 1, wherein the FL BWCU and the FR BWCU each independently execute ABS control software, and directly detect wheel speed through respectively connected wheel speed sensors (WSSs) to perform real-time ABS control for the front wheels.

4. The braking apparatus of claim 3, wherein the FL BWCU and the FR BWCU receive WSS information not only from the wheels to which the FL BWCU and the FR BWCU are directly connected, but also from other BWCUs through local communication, and share, in real time, data required for estimated vehicle speed calculation and brake force distribution.

5. The braking apparatus of claim 1, wherein when the FL BWCU fails,
the RR BWCU detects failure of the FL BWCU and transmits failure information of the FL BWCU to the FR BWCU, and
the FR BWCU backs up and performs a control function including a control area that the FL BWCU was in charge of.

6. The braking apparatus of claim 1, wherein when the FR BWCU fails,
the RL BWCU detects failure of the FR BWCU and transmits failure information of the FR BWCU to the FL BWCU, and
the FL BWCU backs up and performs a control function including a control area that the FR BWCU was in charge of.

7. The braking apparatus of claim 1, wherein according to a designated brake demand determination method,
the FL BWCU determines a brake demand for the FL and RR, and
the FR BWCU determines a brake demand for the FR and RL.

8. The braking apparatus of claim 1, wherein according to a designated brake demand determination method,
the FL BWCU determines a brake demand for the FL, RR and RL, and
the FR BWCU determines a brake demand only for the FR.

9. The braking apparatus of claim 1, wherein the FL BWCU and the FR BWCU operate based on the same control software, so that even if the decision-making entities for calculating a brake demand are divided, the brake demand as a result of calculation is the same or substantially the same level of brake demand.

10. A method for controlling a zonal architecture-based electro-mechanical braking apparatus in which a front left (FL) brake wheel control unit (BWCU) communicatively connected to a first zone control unit also serves as a first central control unit, and a front right (FR) BWCU communicatively connected to a second zone control unit also serves as a second central control unit, the method comprising steps of:
interconnecting the FL BWCU, the rear right (RR) BWCU, and the rear left (RL) BWCU through a first local communication line;
interconnecting the FR BWCU, the RR BWCU, and the RL BWCU through a second local communication line;
monitoring the FL BWCU by the RR BWCU, and monitoring the FR BWCU by the RL BWCU;
when the FL BWCU fails, transmitting, by the RR BWCU, failure information of the FL BWCU to the FR BWCU, and backing up and performing, by the FR BWCU, a control function including a control area that the FL BWCU was in charge of; and
when the FR BWCU fails, transmitting, by the RL BWCU, failure information of the FR BWCU to the FL BWCU, and backing up and performing, by the FL BWCU, a control function including a control area that the FR BWCU was in charge of.
